(19) United States
(12) Patent Application Publication
(10) Pub. No.: US 2005/0168925 A1
(43) Pub. Date: Aug. 4, 2005

(54) Separable and foldable tablet PC assembly

(75) Inventors: Yung Che Fang, Taipei (TW); Shiou Yuan Lin, Taipei (TW); Chen Hsin Chang, Taipei (TW); Chin Pang Hsu, Taipei (TW); Chiang Chih Kuang, Taipei (TW)

Correspondence Address: TROXELL LAW OFFICE PLLC;SUITE 1404, 5205 LEESBURG PIKE, FALLS CHURCH, VA, 22041, US

(73) Assignee: First International Computer Inc.

(21) Appl. No.: 10/766,826

(22) Filed: Jan. 30, 2004

(51) Int. Cl. G06F 1/16

(52) U.S. Cl. 361/683

(57) ABSTRACT

A separable and foldable Tablet PC assembly has a data-inputting device, a combining seat which is pivotally connecting on the data-inputting device, and a slate-like Tablet PC which is received in the combining seat. The combining seat has a base portion, two guiding arms extending upwardly from two sides of the base portion, and a pair of connectors mounted opposite one another on the base portion. The slate-like Tablet PC has a receiving cavity in a bottom thereof and a mating connector on a bottom thereof and corresponding to one of the connectors of the combining seat.

### BACKGROUND OF THE INVENTION

1. Field of the Invention

The present invention relates to a separable and foldable tablet PC assembly, and particularly to a tablet PC combined with a data-inputting device, in which the tablet PC is separable from or foldable with the data-inputting device for independent use or use as a convertible Tablet PC.

2. Description of the Prior Art

The Tablet PC frees us from our desktops. We no longer need to balance a notebook on our knees as we struggle to pay attention and type at the same time. Those who don't like to type now have the option to use handwriting to enter data. Others may prefer speech input, or a combination of both. The Tablet PC's longer battery life gives us more freedom to do what we need to do when we need to do it. We're free to take our computers into meetings and classrooms and to take notes the way that's most familiar, by writing. Because you can write on the screen, it's optimized for tasks that are very common in business computing—like taking notes at a meeting or annotating a document, or for immersive reading.

All Tablet PCs include the revolutionary screen that allows users to write directly on the screen. Handwriting recognition allows us to use our computers as never before.

There are two types of Tablet PCs. The slate models are tablet only, with no attached keyboard. Most have an option for keyboard use if preferred, either wired or wireless. However, the external keyboard cannot draw with the slate model Tablet PC as conveniently as with the notebook.

The convertible Tablet PC is the model most similar to the familiar notebook, see the FIG. 1. The Tablet PC's screen 4a can pivot 180 degrees along a pivoting portion 3a and then fold down on top of the keyboard 2a to create a special writing surface. This allows users to write directly on the surface using a digital pen.

The screen 4a and the keyboard 2a are connected via the pivoting portion 3a and are not separable as the notebook. What the convertible Tablet PC adds is the simplicity of pen and paper via the handwriting/touch screen. The convertible Tablet PC is more complicated than the notebook and has a much higher price. Although presented to the public for a period, it has not become as popular as originally expected.

### SUMMARY OF THE INVENTION

An object of the present invention is to provide a separable and foldable Tablet PC assembly, and in particular, a Tablet PC assembly combining a slate-like Tablet PC with a separable data-inputting device, in which the slate-like Tablet PC is handy and portable when used independently, and is foldable with the data-inputting device as is a convertible Tablet PC.

In order to achieve the above objects, the present invention according to one aspect thereof provides a separable and foldable Tablet PC assembly. The separable and foldable Tablet PC comprises comprising a data-inputting device, a combining seat, and a slate-like Tablet PC. The combining seat comprises a base portion pivotally connected to an side edge of the data-inputting device, two guiding arms extending upwardly from two sides of the base portion, and a pair of connectors mounted opposite on the base portion. The slate-like Tablet PC is received in the combining seat, and comprises a receiving cavity in a bottom thereof and a mating connector on a bottom thereof corresponding to one of the connectors of the combining seat. The slate-like Tablet PC thus can combine with the data-inputting device in a face direction for type-inputting or in an opposite direction for hand-writing inputting via folding therewith, or the slate-like Tablet PC can be separated from the data-inputting device for independent use.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a convertible Tablet PC of the prior art;

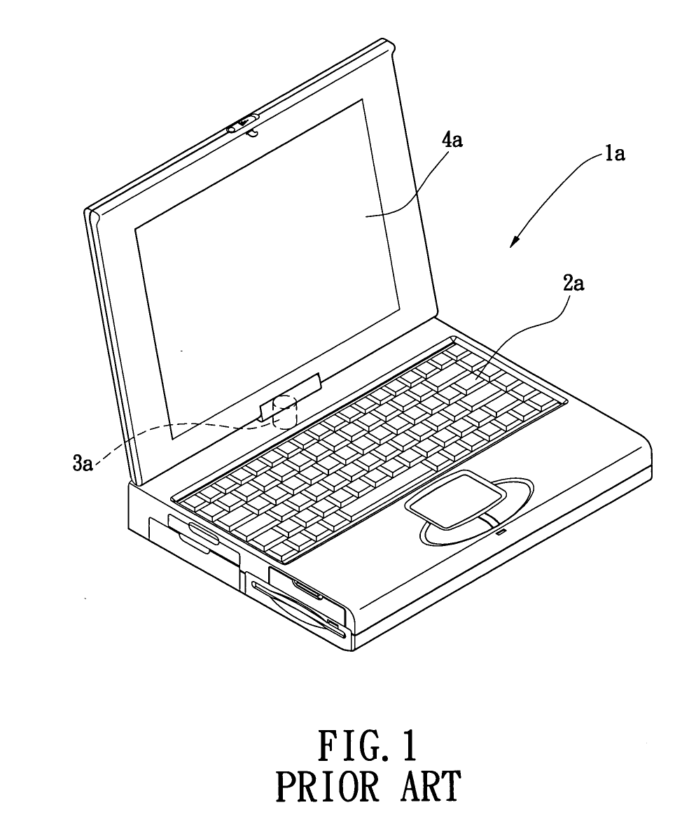

FIG. 2 is an assembly perspective view of a separable and foldable Tablet PC assembly of the present invention;

FIG. 3 is an exploded perspective view of a separable and foldable Tablet PC assembly of the present invention;

FIG. 4 is an assembly perspective view of the present invention with the monitor opposite the data-inputting device;

FIG. 5 is an assembled perspective view of the present invention with the monitor facing and covering the data-inputting device; and

FIG. 6 is an assembled perspective view of the present invention with the monitor opposite and folded on the data-inputting device.

### DESCRIPTION OF THE PREFERRED EMBODIMENT

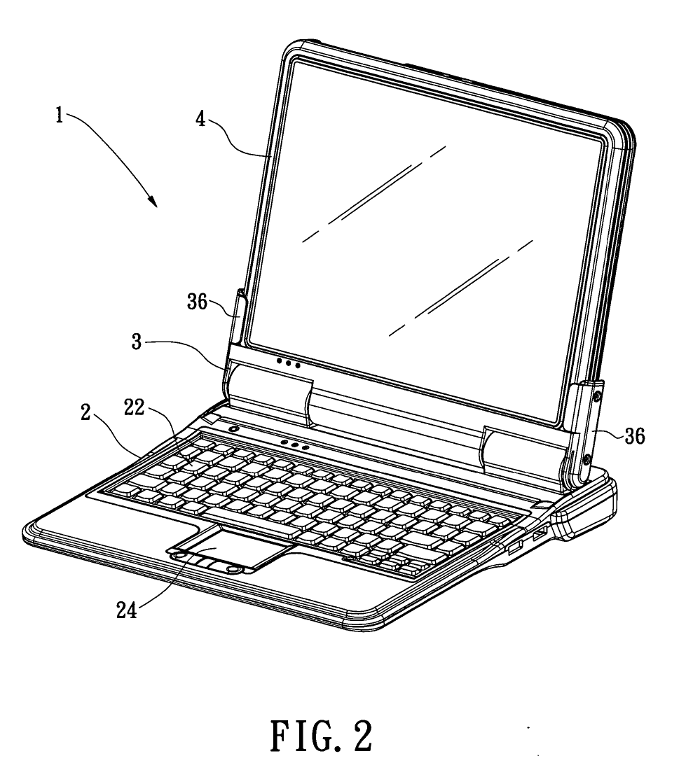

FIG. 2 is an assembled perspective view of a separable and foldable Tablet PC assembly of the present invention. The separable and foldable Tablet PC assembly 1 comprises a data-inputting device 2, a combining seat 3 which is pivotally connected to the data-inputting device 2, and a slate-like Tablet PC 4 which is received in the combining seat 3.

The data-inputting device 2 comprises a keyboard 22 and a touchpad 24 adjacent the keyboard 22 for convenient operation, and in this embodiment, the data-inputting device 2 has an inclined cross-shape with a thicker front edge and a thinner bottom edge, i.e. the bottom edge near the user is lower.

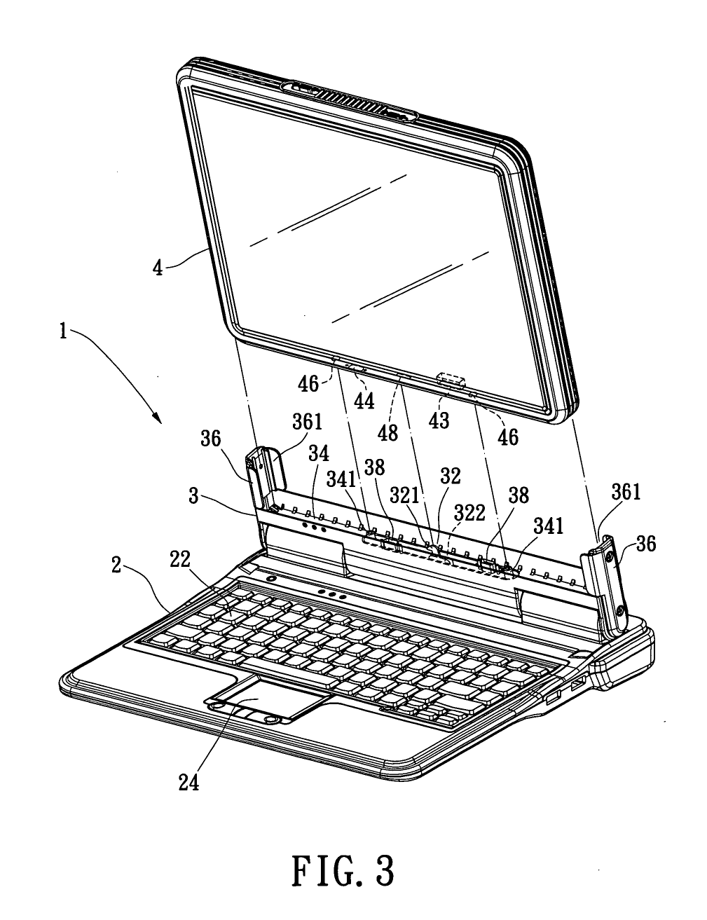

FIG. 3 is an exploded perspective view of a separable and foldable Tablet PC assembly of the present invention. The combining seat 3 comprises a base portion 34 which is pivotally connected to a side edge of the data-inputting device 2, two guiding arms 36 which respectively extend upwardly from two sides of the base portion 34, and a pair of connectors 38 which are mounted opposite each other on the base portion 34.

The slate-like Tablet PC 4 has a hand-writing/touch-sensitive monitor, and is received in the combining seat 3. The slate-like Tablet PC 4 comprises a receiving cavity 43 in a bottom thereof and a mating connector 44 on a bottom thereof corresponding to one of the connectors 38 of the combining seat 3. The slate-like Tablet PC 4 can thereby combine with the data-inputting device 2 in a face direction for type-inputting or in an opposite direction for hand-writing inputting by folding therewith, or the slate-like Tablet PC 4 can be separated from the data-inputting device for independent use.

The combining seat 2 further comprises at least one hooking device 32 for engaging with the slate-like Table PC 4. In this embodiment, the combining seat 2 has one hooking device 32 mounted in a central portion of the base portion 34. The hooking device 32 of the combining seat 3 comprises a sliding button 322, which is slidably mounted on a side surface of the base portion 34, and a hook 321 connected with the sliding button 322 and exposing a top surface of the base portion 34. The slate-like Table PC 4 has a hooking groove 48 formed in a bottom thereof corresponding to the hook 321. The slate-like Table PC 4 is thereby engagable with the combining seat 2.

Each of the guiding arms 36 is formed with a U-shaped guiding recess 361 for clipping and retaining the slate-like Table PC 4 stably in the combining seat 3.

The pair of connectors 38 of the combining seat 3 are disposed opposite each other according to a central portion of the base portion 34, and each connector 38 has a plurality of data-transmitting terminals and a plurality of power-supplying terminals (not shown) for data transmission to and recharging of the slate-like Table PC 4.

The base portion 34 of the combining seat 3 further comprises at least one positioning post 341 protruding from a top surface thereof, and the slate-like Table PC 4 comprises at least one positioning hole 46 formed in a bottom thereof and corresponding to the positioning post 341. In this embodiment, the base portion 34 has two positioning posts 341, and the slate-like Table PC 4 has two positioning holes 46.

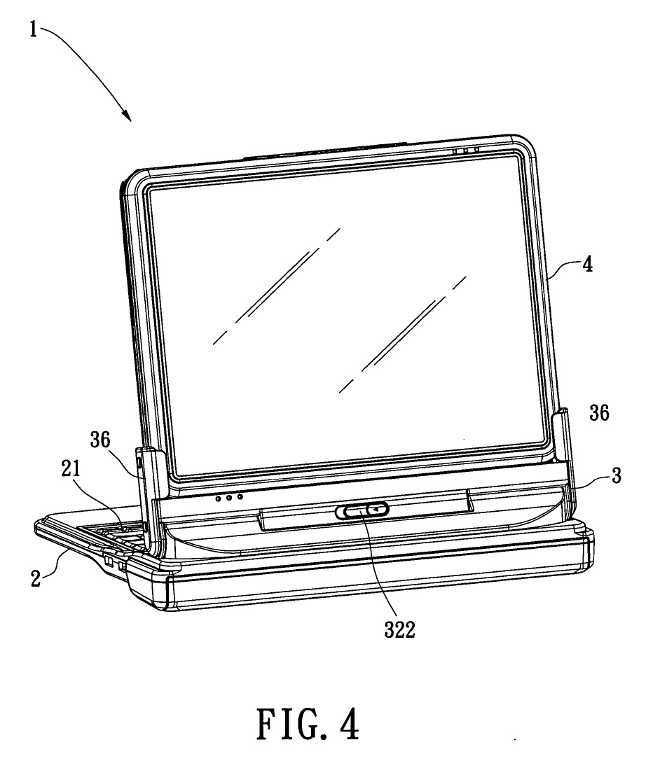

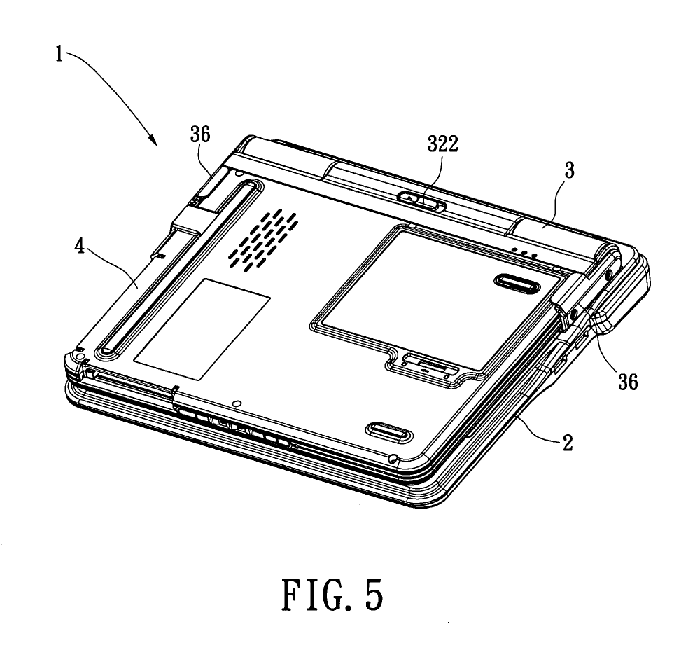

FIGS. 4, 5, and 6, are different assembled perspective views of a separable and foldable Tablet PC assembly of the present invention. When the slate-like Tablet PC 4 is received in the combining seat 3 via the guiding arms 36, the monitor of the slate-like Tablet PC 4 can face the data-inputting device 2 (see FIG. 2) or the data-inputting device 2 (see FIG. 4). At that time, the receiving cavity 43 of the slate-like Tablet PC 4 receives one of the connectors 38 of the combining seat 3, and the mating connector 44 mates with the other of the connectors 38. The slate-like Tablet PC 4 can be fixed at a proper angle and operating with the data-inputting device 2 as a notebook (see FIG. 2), or cover the data-inputting device 2 for protecting the monitor (see FIG. 5).

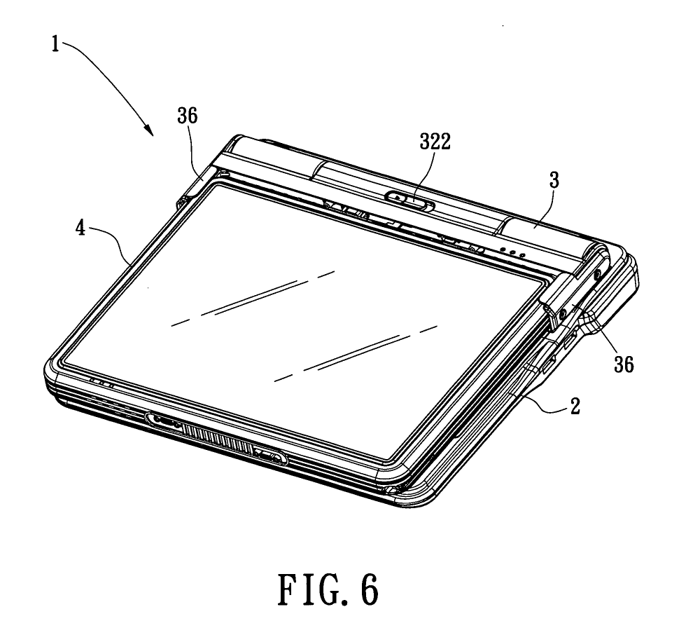

Additionally, the slate-like Tablet PC 4 also can be combined with the data-inputting device 2 in an opposite manner and fold with the data-inputting device 2 (see FIG. 6); therefore the slate-like Tablet PC 4 is convenient for writing input. When the user does not need to input much data, the slate-like Tablet PC 4 can be separated from the data-inputting device 2 by sliding the sliding button 322 of the combining seat 3 for carrying easily and conveniently (see FIG. 3).

The data-inputting device 2 of the present invention also can be a recharging cradle or displaying cradle, when the monitor of the slate-like Tablet PC 4 is replaced on the data-inputting device 2 and fixed at an angle (see FIG. 4).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A separable and foldable Tablet PC assembly comprising:
a data-inputting device;
a combining seat, comprising a base portion pivotally connected to a side edge of the data-inputting device, two guiding arms extending upwardly from two sides of the base portion, and a pair of connectors mounted opposite one another on the base portion; and
a slate-like Tablet PC, received in the combining seat, comprising a receiving cavity in a bottom thereof and a mating connector on a bottom thereof corresponding to one of the connectors of the combining seat;
whereby the slate-like Tablet PC combines with the data-inputting device in a face direction for type-inputting or in an opposite direction for hand-writing inputting via folding therewith, or the slate-like Tablet PC is separated from the data-inputting device for independent use.

2. The separable and foldable Tablet PC assembly as in claim 1, wherein the data-inputting device comprises a keyboard and a touchpad adjacent the keyboard, and the data-inputting device has an inclined cross-shape with a thicker front edge and a thinner bottom edge.

3. The separable and foldable Tablet PC assembly as in claim 1, wherein the combining seat further comprises at least one hooking device for engaging with the slate-like Table PC.

4. The separable and foldable Tablet PC assembly as in claim 3, wherein the hooking device of the combining seat comprises:
a sliding button slidably mounted on a side surface of the base portion; and
a hook connected with the sliding button and exposing a top surface of the base portion;
wherein the slate-like Table PC has a hooking groove formed in a bottom thereof corresponding to the hook, whereby the slate-like Table PC is engagable with the combining seat.

5. The separable and foldable Tablet PC assembly as in claim 1, wherein each guiding arm is formed with a U-shaped guiding recess for clipping and retaining the slate-like Table PC.

6. The separable and foldable Tablet PC assembly as in claim 1, wherein the pair of connectors of the combining seat is disposed opposite one another according to a central portion of the base portion, and each connector has a plurality of data-transmitting terminals and a plurality of power-supplying terminals for data transmission to and recharging of the slate-like Table PC.

7. The separable and foldable Tablet PC assembly as in claim 1, wherein the base portion of the combining seat further comprises at least one positioning post protruding from a top surface thereof, and wherein the slate-like Table PC comprises at least one positioning hole formed in a bottom thereof corresponding to the positioning post.
